(19) United States
(12) Patent Application Publication
(10) Pub. No.: US 2005/0189276 A1
(43) Pub. Date: Sep. 1, 2005

(54) Swimming pool chlorinator

(76) Inventor: Ronald Gail Palmer, Walnut Creek, CA (US)

Correspondence Address: Ronald G. Palmer, 693 Rockcreek Ct., Walnut creek, CA, 94598, US

(21) Appl. No.: 11/060,167

(22) Filed: Feb. 18, 2005

Related U.S. Application Data
(60) Provisional application No. 60/547,883, filed on Feb. 26, 2004.

(51) Int. Cl. C02F 1/50

(52) U.S. Cl. 210/169; 210/198.1

(57) ABSTRACT

A perforated vessel, which holds solid water sanitizing material (usually chlorine tablets) that dissolves in water. The vessel is coupled to the water supply hose of an automatic swimming pool cleaner. The football-like shape of the vessel and the coupling to the pool cleaner hose assures the movement of the vessel around the pool, without hose entanglement, as the pool cleaner moves about the pool. Sanitizer is thereby distributed within the pool water more evenly and more rapidly than is accomplished by commonly used free floating chlorinators.

### CROSS-REFERENCE TO RELATED APPLICATIONS

Provisional Application 60/547,883 dated Feb. 26, 2004

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Heretofore, the most common means of sanitizing residential swimming pool water have been periodically, manually adding liquid or granular chlorine, or the use of perforated floating chlorinators that contain chlorine tablets and float freely on the surface of the pool. The objective of pool water chlorination is to maintain a constant, adequate level of sanitizer in the water to preclude bacteria and algae contamination of the water. The manual addition of liquid or granular chlorine requires frequent personal attention and results in erratic chlorine concentration. The free floating chlorinator contains chlorine tablets that erode resulting in high chlorine concentrations in the immediate vicinity of the chlorinator; consequently, chlorine distribution throughout the pool is uneven and the high chlorine concentration around the chlorinator can damage the pool surface if the floating chlorinator spends extensive time over a pool step or seat. Since the floating chlorinator is freely floating on the surface of the pool, there is little water flowing through the floater's perforations and, therefore, chlorine tablet erosion is very slow. Most pool owners would find it desirable to have the low maintenance benefits of a free floating chlorinator and the additional benefits that would be derived from a means of increasing the movement of the chlorinator over the pool surface; increased chlorine tablet erosion rate, improved chlorine distribution throughout the pool, and reduced pool surface damage due to high chlorine levels in the vicinity of pool steps and seats.

### BRIEF SUMMARY OF THE INVENTION

The object of the invention is to provide an easy means of distributing solid chlorine, or any other solid sanitizer, in a swimming pool with the advantages of doing so more uniformly and at a higher rate of chlorine tablet erosion than can be achieved with a free floating chlorinator. Since the chlorine tablet is the solid sanitizer most commonly used to sanitize residential swimming pool water, the invention will be described in terms of its ability to function with chlorine tablets, although any solid sanitizer that dissolves in water will also work in the invention.

The invention is a perforated football-shaped vessel, which contains chlorine tablets and is attached to an automatic pool cleaner's water supply hose. As the automatic pool cleaner moves around the pool during its routine pool cleaning cycle, the invention moves with the hose causing water to flow through the perforations, which erodes the chlorine tablets and chlorinates the water. The football-like shape of the vessel precludes hose entanglement around the vessel.

### BRIEF DESCRIPTION OF THE DRAWING

FIG. 1 shows the features of the invention with the pool cleaner hose inserted. The hose passes through the center of invention, which insures that the invention moves with the hose. The football-like shape of the invention precludes loops of the hose from getting wrapped around the invention. Perforations in the outer shell of the invention permit the chlorine tablets to be inserted into the interior of the vessel.

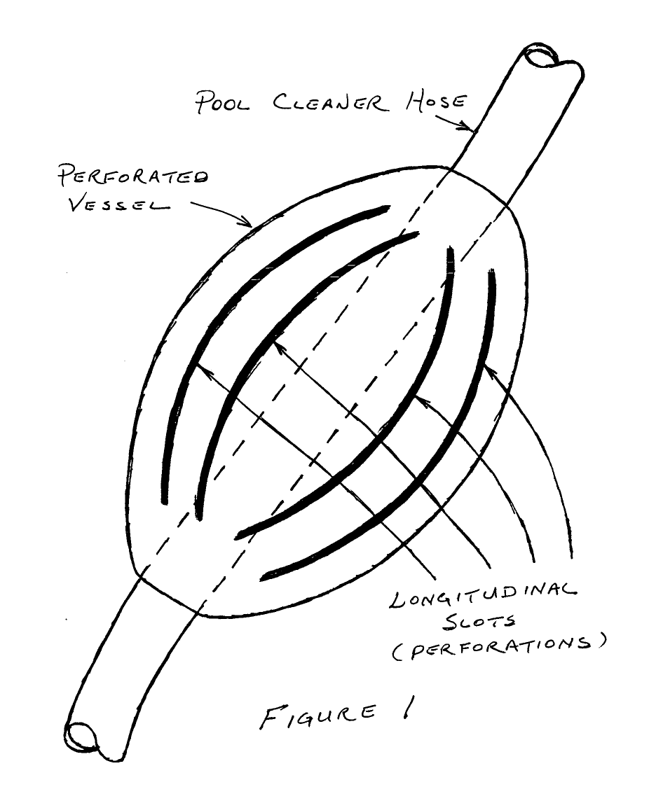

FIG. 2 shows the invention installed in a swimming pool.

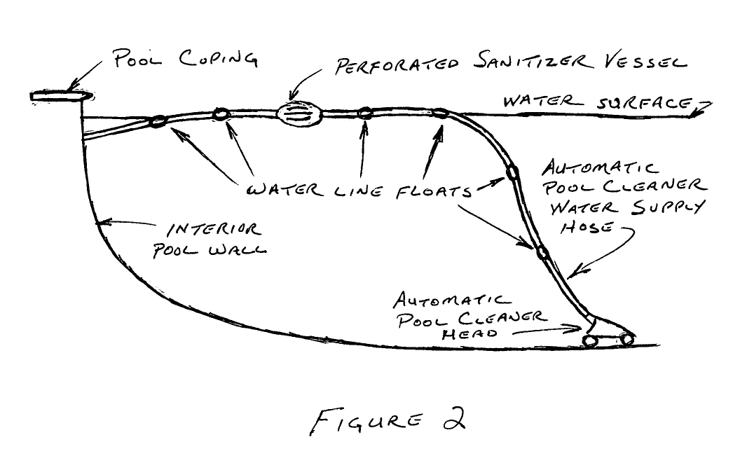

### DETAILED DESCRIPTION OF THE INVENTION

The invention is fabricated from an eight inch long plastic swimming pool lane marker float having the same inside diameter as the outside diameter of the automatic pool cleaner hose. The float is used as a vessel that is slid onto the pool cleaner hose. A table saw with a masonry blade is used to cut the perforations longitudinally in the float. The outer sections or the float, between the perforations, are depressed to allow access to the interior of the vessel. Chlorine tablets are inserted into the interior of the vessel while depressing a section between perforations.

The invention has the following advantages relative to free floating chlorinators:
1) Since the invention moves with the movement of the pool cleaner hose, water circulates through the vessel via the perforations resulting in more rapid erosion of the chlorine tablets due to the velocity of the water past the surface of the tablets. This is important because the free floating chlorinator often provides insufficient chlorination and must be supplemented with manual additions of chlorine.
2) The movement of the invention around the pool, in conjunction with the automatic cleaner, provides more even distribution of chlorine throughout the pool than the free floating chlorinator provides with its limited movement.
3) The propensity of the free floating chlorinator to stay next to the pool wall or over the steps or love seat in the pool, can cause accelerated deterioration of the pool plaster or liner, due to the high concentration of chlorinated, low pH water in the immediate vicinity of the floating chlorinator. The position of the invention within the pool is determined by the location of the automatic pool cleaner. Even when the pool cleaner is not running, the invention is usually away from the side wall, steps, and love seats because the invention is located on the hose between the wall connection and the pool cleaner head.
4) The free floating chlorinator is an enclosed vessel with a lid that must be removed to determine if additional chlorine tablets are needed. Consequently, the supply of tablets in the floating chlorinator's reservoir often run low or completely out before the lid is removed. The invention is slightly submerged when full of chlorine tablets and rises toward the surface as tablets erode; thus, it is easier to ascertain chlorine tablet content by observing the buoyancy of the invention.

1. A swimming pool water sanitizer comprising:
A) a perforated vessel in which solid water-sanitizing chemicals are placed
B) a means of coupling the vessel to the water supply hose of an automatic swimming pool cleaner.
